(19) United States
(12) Patent Application Publication
(10) Pub. No.: US 2017/0290261 A1
(43) Pub. Date: Oct. 12, 2017

(54) Weed and grass trimmer with deflection plates

(71) Applicant: Raymond Floyd, Cody, WY (US)

(72) Inventor: Raymond Floyd, Cody, WY (US)

(73) Assignee: Raymond Floyd, Cody, WY (US)

(21) Appl. No.: 15/095,018

(22) Filed: Apr. 9, 2016

(51) Int. Cl. A01D 34/416

(52) U.S. Cl. CPC A01D 34/4167; A01D 34/4163

(57) ABSTRACT

An improved guard is provided for hand-held cutting edge devices such as lawn trimmers. The guard extends beyond the cutting plane formed by the circular travel of the flexible cutting element. The extended guard protects against foreign objects being propelled by the cutting element, possibly causing damage or physical harm. A cutter may be provided inside the perimeter of the guard, extending into the plane formed by the cutting element to function as a cutter for setting the length of the cutting element being used. The guard may be formed as a single piece or as a composite which when assembled encircles the center assembly of the cutting element.

### FIELD OF THE INVENTION

This invention relates to string-type powered lawn trimmers, and more particularly to trimmer guards that may be used to shield the user from injury or other matter from damage by foreign objects propelled by the cutting element.

### BACKGROUND OF THE INVENTION

Powered weed and grass trimmers, which have rotating cutting elements, are commonly used to edge lawns and cut vegetation that conventional lawnmowers cannot reach or otherwise cannot be used. The cutting elements are typically flexible members, string, plastic, light chain, or similar materials, rotating in a planar cutting circle. The power for such rotating elements may be provided by an electric motor or gasoline engine located at one end of the trimmer, with a rotating shaft coupled to the cutting element. A guard housing is typically provided to form a partial shield between the operator of the unit and any foreign objects which may be expelled by the cutting action of the cutting element. The guard housing typically extends one-quarter to no more than one-half of the circumference of the cutting plane, and is mounted to the rear of the element. The cutting element is thus exposed to the forward area of the cutting plane, and can present dangerous operation to possible injury to the operator or others by launching foreign object debris upward in the forward, un-shrouded portion of the cutting plane. In addition to the possible projectiles associated with the cutting element, the cutting element itself is exposed to damage from coming into contact with hard objects, trees, or other material that could cause breakage of the cutting element. This breakage often requires the operator to replace the cutting element, or, at a minimum, causing new cutting elements to be fed from an on-board storage unit. The guard housing will typically have some type of sharp blade mounted on the periphery of the housing, extending approximately one-half inch into the cutting plane. The purpose of this blade is to ensure that the cutting element is limited in length to a radius approximately one-half inch smaller than the radius of the guard.

### SUMMARY OF THE INVENTION

The present invention provides an improved guard for conventional lawn trimmers, typically having a string-type cutting blade that rotates in a planar cutting circle. The guard is attached to the trimmer shaft using any of several attachment means, including but not limited to bolts, screws, brackets, clamps, and like methods. The point of the guard attachment to the shaft is a point located above the trimmer head so that the guard lies between the trimmer head and the operator controls.

The guard is preferably circular, and in any embodiment extends a full 360 degrees around and below the periphery of the cutting circle formed by the cutting element. In the preferred embodiment, the guard occupies a uniform arc about the cutting element's axis of rotation and extends its lower edge to approximately two inches below the plane of the cutting element. The guard slots will alternate solid sections with openings, approximately ¼ to ⅜^{th} of an inch in width. The guard will provide a cutting blade on the inner side of the guard face to provide a limit on the radius of the cutting element. The guard may be fabricated from any suitable durable and rigid material or casting. The material may be of metal or plastic.

### BRIEF DESCRIPTION OF DRAWINGS

FIG. 1 is an illustration of a typical powered grass trimmer.

FIG. 2 is an illustration of a typical grass trimmer guard.

FIG. 3 is an illustration of the cross section of the invention with the cutting element.

FIG. 4 is an illustration of the invention profile.

FIG. 5 is an illustration of typical powered grass trimmer with the new guard in place.

### DETAILED DESCRIPTION OF THE PREFERRED EMBODIMENT

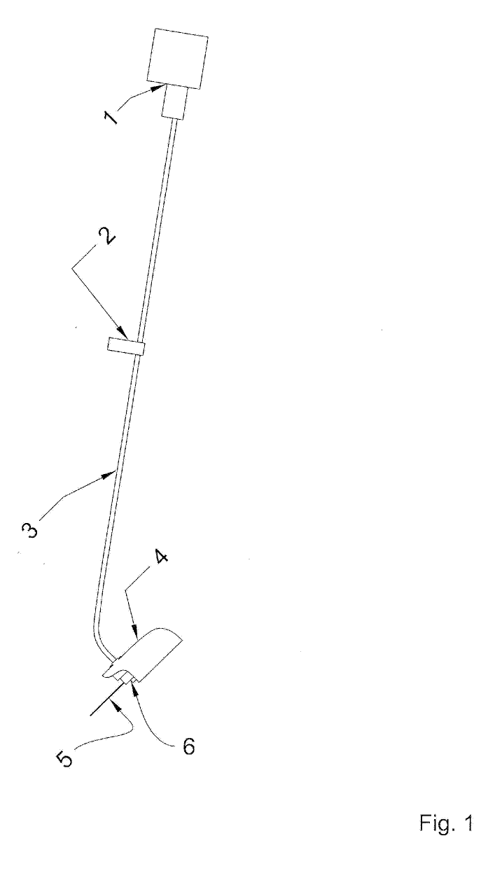

FIG. 1 is a typical powered grass trimmer. The power is provided by the power unit 1, which may be gasoline or electric powered. An operator handle 2 is provided for use during cutting operation. The motor drive connection is connected to the trimmer head via a hollow tube 3, transferring the power unit rotation to the cutter head rotating unit. The cutter head unit has a safety shield 4, which typically provides protection for the operator and is normally between 90 and 120 degrees of rotation on the backside of the cutter head. The cutter head contains the flexible cutting line 5 which is rotating via the power provided by the power unit 1. The flexible cutting line 5 may be supplied by a mechanically released spool 6.

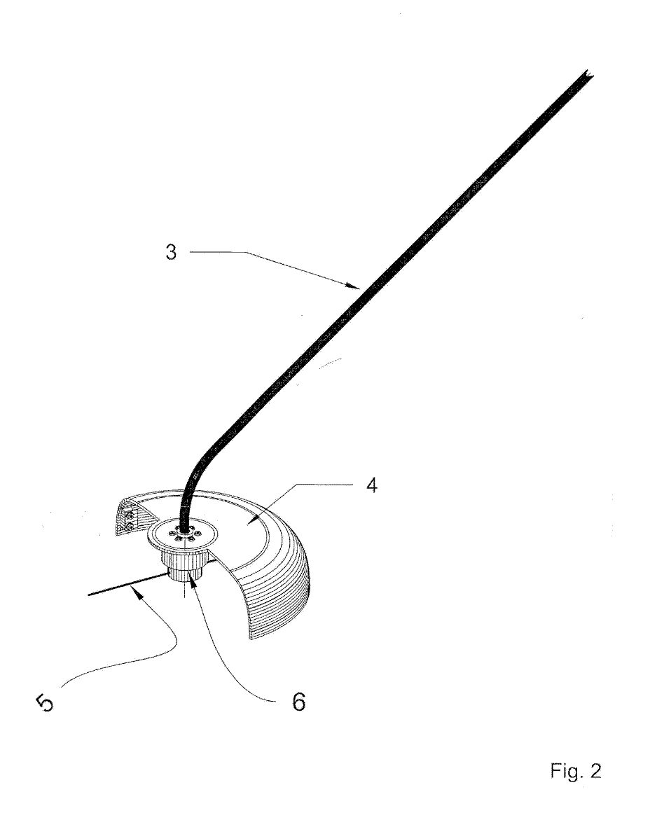

FIG. 2 illustrates a typical operator safety shield 4 providing a shield of 90 to 120 degrees of shield protection from thrown objects during operation of the power trimmer. The power to the flexible cutting line is provided through the unit handle 3. The flexible cutting line 5 may be supplied by a mechanical release spool 6.

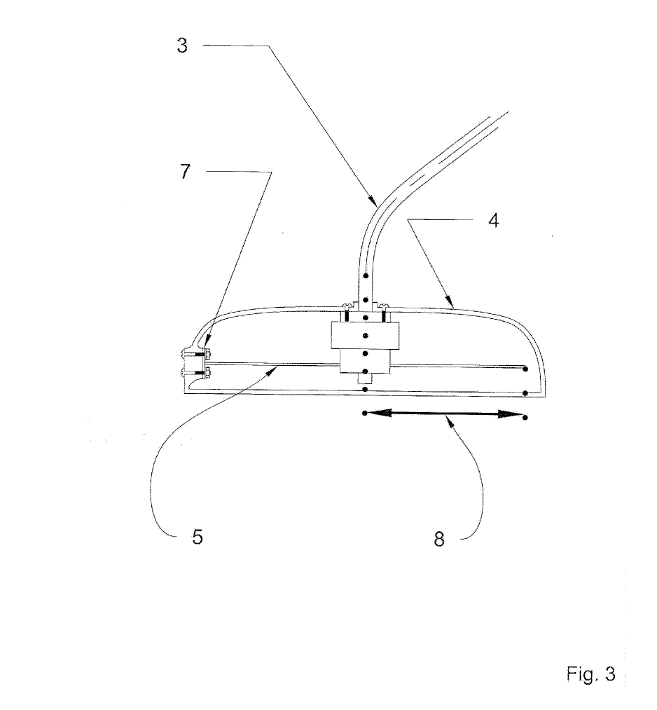

FIG. 3 provides an illustration of the preferred embodiment of the invention. The power to the rotating element is provided via the unit handle 3. The safety shield 4 in the preferred embodiment is a full 360 degree shield, providing protection from thrown objects in all directions during operation of the grass trimmer. The flexible cutting element 5 is connected to the drive element, and rotates via power from the power unit. The flexible cutting element length 8 is maintained during operation via the cutter 7.

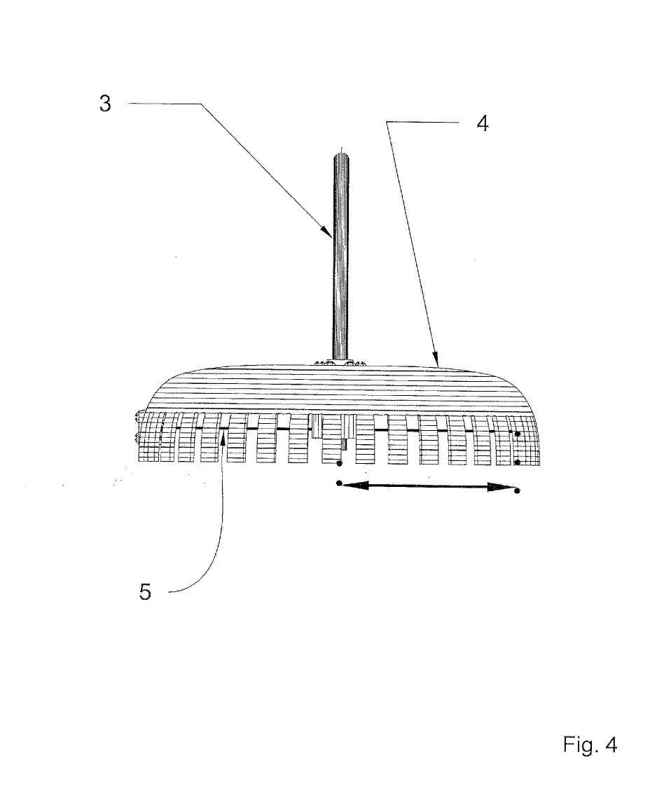

FIG. 4 illustrates the preferred embodiment with the shield 4 with the slotted section visible. The rotating head, powered via the operator handle 3 is completely surrounded by the shield 4, preventing foreign objects from being propelled by the flexible cutting line 5.

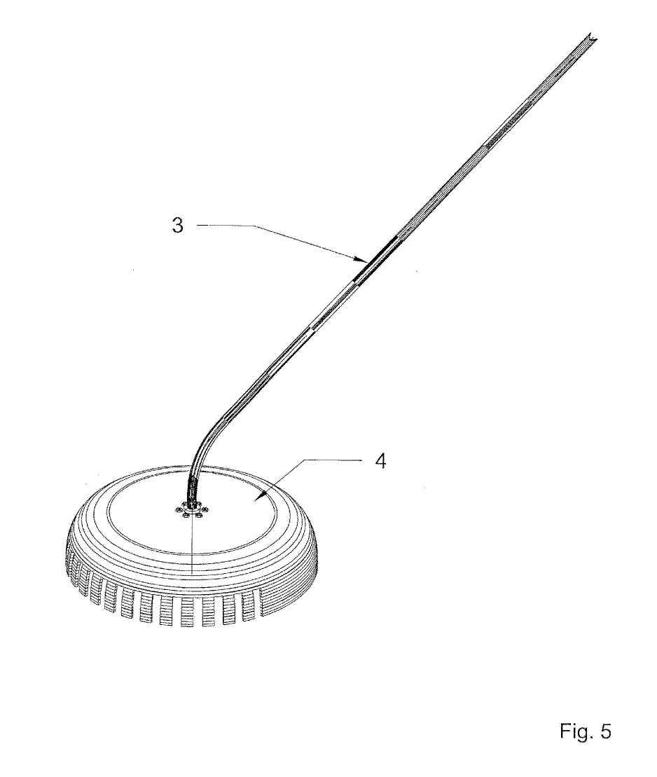

FIG. 5 illustrates the preferred embodiment with the shield 4 with the slotted section visible. The operator handle 3, is also illustrated.

What is claimed is:

1. A guard for a flexible element cutting device having at least one cutting element traveling in a circular plane, the cutting element having a length, a center of rotation, and a distal end, the guard comprising a guard portion and a perimeter slotted edge, the perimeter slotted edge forming a continuous circular edge around the circular plane of travel of the cutting element at a radius less than the length of the cutting element.

2. A guard for a flexible element cutting device according to claim 1, wherein the radius is between 85% and 95% of the length of the cutting element.

3. A guard for a flexible element cutting device according to claim 1, wherein said perimeter edge is spaced apart from said circular plane between ⅛″ and ⅜″.

4. A guard for a flexible element cutting device according to claim 1, wherein said guard portion forms an arcuate circle of rotation.

5. A guard for a flexible element cutting device according to claim 1, wherein said guard portion has ¼″ slots in the frontal peripheral area 90 to 180 degrees to allow material entrance to the cutting element.

6. A guard for a flexible element cutting device according to claim 1, further comprising at least one cutter attached to said guard portion, said cutter being located at a radius greater than the radius of the perimeter edge and extending into the circular plane of travel of at least one cutting element.
